(19) United States
(12) Patent Application Publication
(10) Pub. No.: US 2006/0253498 A1
(43) Pub. Date: Nov. 9, 2006

(54) Method and apparatus for reclaiming memory from a heap

(75) Inventors: John William Barrs, Austin, TX (US); Michael Wayne Brown, Georgetown, TX (US); Paul Stuart Williamson, Round Rock, TX (US)

Correspondence Address: DUKE W. YEE;YEE & ASSOCIATES, P.C., P.O. BOX 802333, DALLAS, TX, 75380, US

(73) Assignee: International Business Machines Corporation, Armonk, NY (US)

(21) Appl. No.: 11/122,695

(22) Filed: May 5, 2005

(51) Int. Cl. G06F 17/30

(52) U.S. Cl. 707/200

(57) ABSTRACT

An improved method, apparatus, and computer instructions for managing a heap. Live objects in portions of space in the heap are marked in response to a request to reclaim space in the heap. The portions of space are moved into a virtual memory in response to marking the live objects. The old objects are removed from the portions of space in the heap in the virtual memory.

### CROSS REFERENCE TO RELATED APPLICATIONS

The present invention is related to the following patent applications: entitled “Method and Apparatus for Dimensional Data Versioning and Recovery Management”, Ser. No. 11/037,127, attorney docket no. AUS920040309US1, filed on Jan. 18, 2005; entitled “Method and Apparatus for Data Versioning and Recovery Using Delta Content Save and Restore Management”, Ser. No. 11/037,157, attorney docket no. AUS920040638US1, filed on Jan. 18, 2005; entitled “Platform Infrastructure to Provide an Operating System Based Application Programming Interface Undo Service”, Ser. No. 11/037,267, attorney docket no. AUS920040639US1, filed on Jan. 18, 2005; entitled “Virtual Memory Management Infrastructure for Monitoring Deltas and Supporting Undo Versioning in a Paged Memory System”, Ser. No. 11/037,000, attorney docket no. AUS920040640US1, filed on Jan. 18, 2005; entitled “Infrastructure for Device Driver to Monitor and Trigger Versioning for Resources”, Ser. No. 11/037,268, attorney docket no. AUS920040641US1, filed on Jan. 18, 2005; entitled “Method and Apparatus for Managing Versioning Data in a Network Data Processing System”, Ser. No. 11/037,001, attorney docket no. AUS920040642US1, filed on Jan. 18, 2005; entitled “Heap Manager and Application Programming Interface Support for Managing Versions of Objects”, Ser. No. 11/037,024, attorney docket no. AUS920040643US1, filed on Jan. 18, 2005; entitled “Method and Apparatus for Marking Code for Data Versioning”, Ser. No. 11/037,322, attorney docket no. AUS920040644US1, filed on Jan. 18, 2005; entitled “Object Based Access Application Programming Interface for Data Versioning”, Ser. No. 11/037,145, attorney docket no. AUS920040645US1, filed on Jan. 18, 2005; entitled “Method and Apparatus for Aging a Versioned Heap System”, Ser. No. ______, attorney docket no. AUS920040835US1, filed on ______; assigned to the same assignee, and incorporated herein by reference.

### BACKGROUND OF THE INVENTION

1. Technical Field

The present invention relates to an improved data processing system, and in particular, to a method, apparatus, and computer instructions for processing data. Still more particularly, the present invention relates to a method, apparatus, and computer instructions for managing versions of objects.

2. Description of Related Art

Data storage components, variables, collections, and multi-dimensional collections are used throughout all computer applications. During the execution of an application, the contents of these types of data storage elements will change or evolve. These changes occur due to modifications or updates to the data. These changes may be made by user input or through programmatic means.

In a Java virtual machine, a heap is an area in which all of the objects created by an application are stored. During the course of executions, some objects may no longer be needed or used by an application. These types of objects are considered to be old objects. As more and more objects are created, the amount of space in the heap decreases. At some point in time, it is appropriate or useful to clear out or free objects that are no longer being used by an application. This process is referred to as garbage collection. In other words, the old objects are no longer needed by the program and can be removed or thrown out. This process involves memory recycling. When an object is old, the space in the heap occupied by this object may be recycled such that the space is made available for subsequent new objects. An object is considered old when the object is no longer referenced by a program or application. A program or application has a reference to an object, which allows the program or application to manipulate the object. A reference is similar to a pointer.

Garbage collection algorithms perform two basic functions. First, these types of processes detect garbage objects. Second, these processes make space available to programs. These two functions are also referred to as marking and sweeping. During a mark phase, the heap is searched and objects that are still referenced by other objects or applications are marked. During a sweep phase, free space between marked objects is identified. Garbage collection is time consuming because all of the threads for live tasks are locked during garbage collection.

Therefore, it would be advantageous to have an improved method, apparatus, and computer instructions for reclaiming memory from a heap.

### SUMMARY OF THE INVENTION

The present invention provides an improved method, apparatus, and computer instructions for managing a heap. Live objects in portions of space in the heap are marked in response to a request to reclaim space in the heap. The portions of space are moved into a virtual memory in response to marking the live objects. The old objects are removed from the portions of space in the heap in the virtual memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in which the present invention may be implemented;

FIG. 3 is a block diagram of a JVM in accordance with a preferred embodiment of the present invention;

FIG. 4 is a diagram illustrating components used in data versioning and recovery in accordance with a preferred embodiment of the present invention;

FIG. 5 is a diagram illustrating components used in providing data versioning and recovery management in accordance with a preferred embodiment of the present invention;

FIG. 6 is a diagram illustrating a delta object linked list in accordance with a preferred embodiment of the present invention;

FIG. 7 is a diagram of a delta object linked list in accordance with a preferred embodiment of the present invention;

FIG. 8 is a diagram illustrating marked code in accordance with a preferred embodiment of the present invention;

FIG. 9 is an example of marked code in accordance with a preferred embodiment of the present invention;

FIG. 10 is a block diagram of components illustrating managing a heap in accordance with a preferred embodiment of the present invention;

FIG. 11 is a flowchart of a process for allocating objects in accordance with a preferred embodiment of the present invention;

FIG. 12 is a flowchart of a process for storing delta data in accordance with a preferred embodiment of the present invention;

FIG. 13 is a flowchart of a process for returning an object to an earlier state in accordance with a preferred embodiment of the present invention;

FIG. 14 is a flowchart of a process for restoring an object to an earlier state in accordance with a preferred embodiment of the present invention;

FIG. 15 is a flowchart of a process for marking code for versioning in accordance with a preferred embodiment of the present invention;

FIG. 16 is a flowchart of a process for tracking changes in data in accordance with a preferred embodiment of the present invention;

FIG. 17 is a flowchart of a process for managing versioning data in a heap in accordance with a preferred embodiment of the present invention;

FIG. 18 is a flowchart of a process for moving versioning data to a persistent storage in accordance with a preferred embodiment of the present invention;

FIG. 19 is a flowchart of a process for performing garbage collection on a heap containing versioning data in accordance with a preferred embodiment of the present invention;

FIG. 20 is a flowchart of a process for reclaiming memory in a heap in accordance with a preferred embodiment of the present invention;

FIG. 21 is a flowchart of a process for swapping an object from virtual memory into a heap in accordance with a preferred embodiment of the present invention;

FIG. 22 is a flowchart for moving objects into persistent storage based on addresses of the objects in accordance with a preferred embodiment of the present invention;

FIG. 23 is a flowchart for aging objects in a heap in accordance with a preferred embodiment of the present invention;

FIG. 24 is a flowchart for identifying when an object has been referenced in accordance with a preferred embodiment of the present invention;

FIG. 25 is a flowchart for moving objects to persistent storage in accordance with a preferred embodiment of the present invention; and

FIG. 26 is a flowchart for processing a portion of a heap in accordance with a preferred embodiment of the present invention.

### DETAILED DESCRIPTION OF THE PREFERRED EMBODIMENT

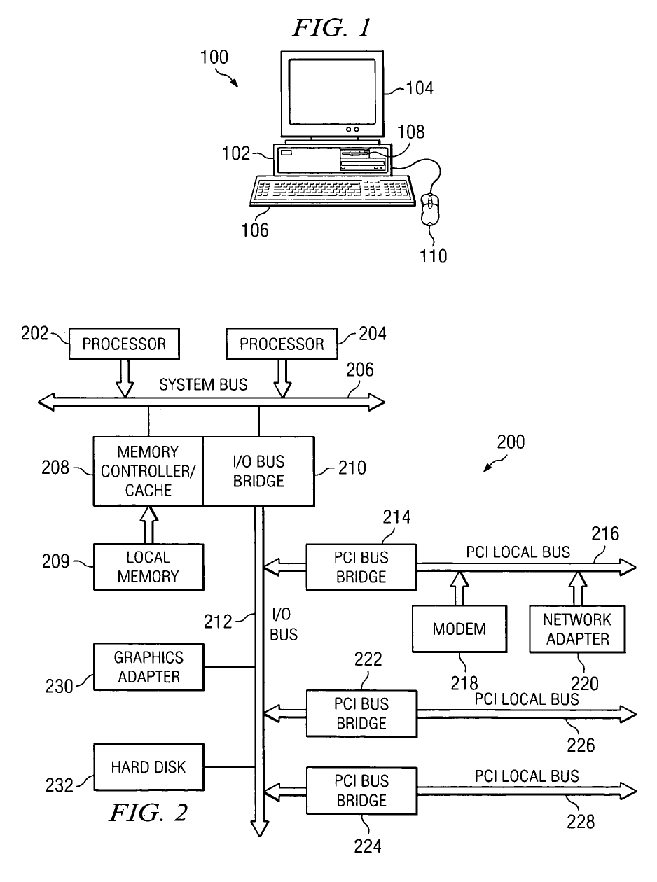

With reference now to the figures, FIG. 1 is a pictorial representation of a data processing system in which the present invention may be implemented in accordance with a preferred embodiment of the present invention. Computer 100 is depicted which includes system unit 102, video display terminal 104, keyboard 106, storage device 108, which may include floppy drives and other types of permanent and removable storage media, and mouse 110. Additional input devices may be included with personal computer 100, such as, for example, a joystick, touch pad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

FIG. 2 is a block diagram of a data processing system in which the present invention may be implemented. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to other data processing systems may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware in FIG. 2 may vary. For example, other peripheral devices, such as optical disk drives and the like, also may be used in addition to or in place of the hardware depicted. The depicted example is not meant to imply architectural limitations with respect to the present invention.

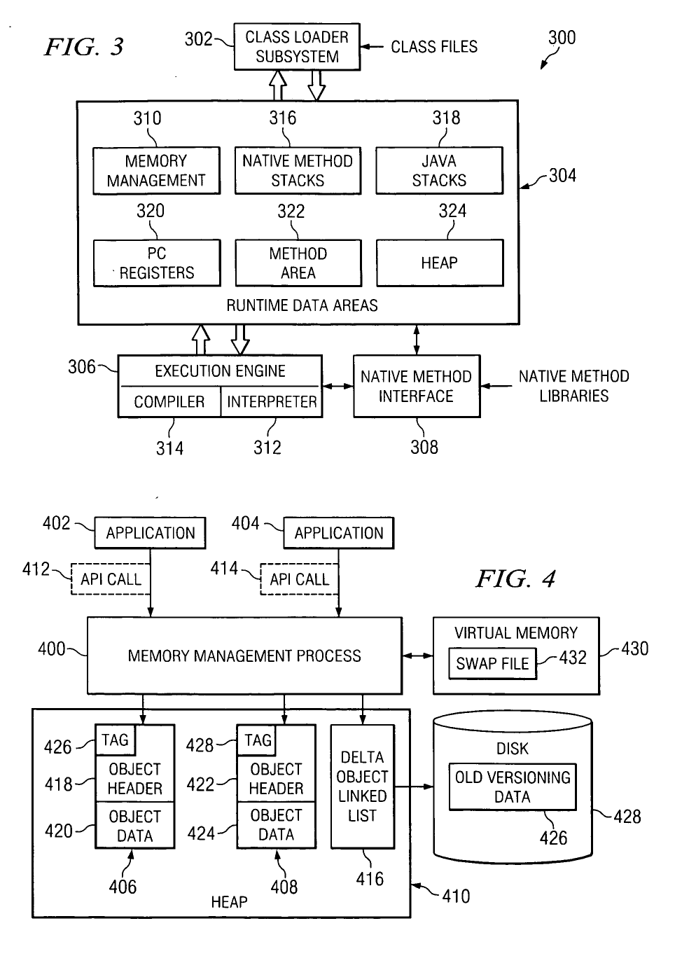

FIG. 3 is a block diagram of a Java virtual machine (JVM) in accordance with a preferred embodiment of the present invention. JVM 300 includes class loader subsystem 302, which is a mechanism for loading types, such as classes and interfaces, given fully qualified names. JVM 300 also contains runtime data areas 304, execution engine 306, native method interface 308, and memory management 310. Execution engine 306 is a mechanism for executing instructions contained in the methods of classes loaded by class loader subsystem 302. Execution engine 306 may be, for example, Java interpreter 312 or just-in-time compiler 314. Native method interface 308 allows access to resources in the underlying operating system. Native method interface 308 may be, for example, the Java Native Interface (JNI).

Runtime data areas 304 contain native method stacks 316, Java stacks 318, PC registers 320, method area 322, and heap 324. These different data areas represent the organization of memory needed by JVM 300 to execute a program.

Java stacks 318 are used to store the state of Java method invocations. When a new thread is launched, the JVM creates a new Java stack for the thread. The JVM performs only two operations directly on Java stacks: it pushes and pops frames. A thread's Java stack stores the state of Java method invocations for the thread. The state of a Java method invocation includes its local variables, the parameters with which it was invoked, its return value, if any, and intermediate calculations. Java stacks are composed of stack frames. A stack frame contains the state of a single Java method invocation. When a thread invokes a method, the JVM pushes a new frame onto the Java stack of the thread. When the method completes, the JVM pops the frame for that method and discards it. The JVM does not have any registers for holding intermediate values; any Java instruction that requires or produces an intermediate value uses the stack for holding the intermediate values. In this manner, the Java instruction set is well defined for a variety of platform architectures.

Program counter (PC) registers 320 are used to indicate the next instruction to be executed. Each instantiated thread gets its own PC register and Java stack. If the thread is executing a JVM method, the value of the PC register indicates the next instruction to execute. If the thread is executing a native method, then the contents of the PC register are undefined. Native method stacks 316 stores the state of invocations of native methods. The state of native method invocations is stored in an implementation-dependent way in native method stacks, registers, or other implementation-dependent memory areas. In some JVM implementations, native method stacks 316 and Java stacks 318 are combined.

Method area 322 contains class data while heap 324 contains all instantiated objects. A heap is an area of memory reserved for data that is created at runtime. The constant pool is located in method area 322 in these examples. The JVM specification strictly defines data types and operations. Most JVMs choose to have one method area and one heap, each of which is shared by all threads running inside the JVM, such as JVM 300. When JVM 300 loads a class file, it parses information about a type from the binary data contained in the class file. JVM 300 places this type of information into the method area. Each time a class instance or array is created, the memory for the new object is allocated from heap 324. JVM 300 includes an instruction that allocates memory space within the memory for heap 324 but includes no instruction for freeing that space within the memory. Memory management 310 in the depicted example manages memory space within the memory allocated to heap 324. Memory management 310 may include a garbage collector, which automatically reclaims memory used by objects that are no longer referenced. Additionally, a garbage collector also may move objects to reduce heap fragmentation.

The present invention provides a memory management subsystem to provide for data versioning and recovery management for objects in a heap. The mechanism of the present invention saves modifications or deltas in data when objects in memory are changed. A delta in data is the difference between the data in its prior version and its current version. The different deltas may be used to restore objects to a prior state. These deltas also are referred to as delta data. In these illustrative examples, the memory management subsystem may include, for example, memory management 310 and heap 324 in FIG. 3.

The mechanism of the present invention modifies this heap to include objects for restoring delta data. In these examples, delta data represents change values or data for a particular memory object. This delta data is associated with an index. This index may take various forms, such as a number or a timestamp. In particular, these changes are stored in a data structure, for example, a linked list in a heap. The mechanism of the present invention modifies the memory management system to automatically generate this linked list in the heap of a JVM without requiring any special requests from applications or the user. Alternatively, the objects may be allocated in the heap to include the delta data.

In particular, these changes between the prior data and the current data in its changed form are stored in a data structure, such as, for example, a linked list in a heap. The data structure is associated with a memory object. In the illustrative examples, a memory object is associated with the versioning data structure using at least one of a pointer and an offset. The mechanism of the present invention modifies the memory management system to automatically generate this linked list in the heap of a JVM without requiring any special requests from applications or the user.

The mechanism of the present invention also provides an ability to manage versioning data stored in versioning data structures based on the age of the versioning data. This mechanism allows for versioning data that is considered to be old to be removed from the heap in the JVM. This old versioning data may be sent to a persistent storage, such as a disk drive.

The mechanism of the present invention also provides a method, apparatus, and computer instructions for managing a heap. More specifically, the mechanism of the present invention allows for reclaiming memory in a heap while reducing or eliminating the need to lock threads for tasks during garbage collection. When garbage collection occurs, a block of space in the heap is scanned for live objects. Identified live objects are marked. The block of heap space is written to a virtual memory. This virtual memory may be, for example, a swap file located on a disk. Virtual memory is used to simulate more physical memory than actually exists. This type of memory allows a data processing system to run larger programs or more programs concurrently. A virtual memory process is used to break up a program or data structures into small segments, called “pages” and brings as many pages from disk into memory that fit into a reserved area for that program or data structure. When additional pages are required, this memory management process makes room for the additional pages by swapping them to a disk. The memory management process keeps track of pages that have been modified so that they can be retrieved when needed again.

As a result, the garbage collection process does not need to lock all of the threads. Old objects may be removed, freeing up space, using the portions or block of heap space that is located in virtual memory. Additionally, this freeing of space may be performed as a background operation. If an object in the heap space located in virtual memory is later referenced, that object may be swapped back into the heap from the virtual memory. As a background operation, the freeing of space may occur, as processor time is available. In this manner, other tasks in the foreground may occur with a higher priority than the garbage collection process. As a result, a user does not notice a slow down in operation when a garbage collection process using this mechanism of the present invention is initiated.

The mechanism of the present invention also may mark live objects in the heap and move portions of the heap into a virtual memory. Objects considered old in the portions of the heap moved into the virtual memory may be moved from the virtual memory into a persistent storage. An old object in the persistent storage may be moved back into the heap if the old object is referenced.

FIG. 4 is a diagram illustrating components used in data versioning and recovery in accordance with a preferred embodiment of the present invention. Memory management process 400 receives requests from applications, such as application 402 and application 404 to allocate objects, such as objects 406 and 408. Memory management process 400 may be implemented in a memory management component, such as memory management 310 in JVM 300 in FIG. 3.

In these examples, the requests from application 402 and application 404 take the form of application programming interface (API) call 412 and API call 414. An API is a language and message format used by an application program to communicate with the operating system. APIs are implemented by writing function calls in the program, which provide the linkage to the required subroutine for execution. If these API calls include an argument or parameter indicating that delta data should be stored for restoring prior versions of an object, objects 406 and 408 are allocated in a manner to allow for versioning of the objects to occur. In other words, changes in data in these objects are stored in a manner to allow the objects to be restored to a prior version.

In these illustrative examples, this delta data is maintained using delta object linked list 416, which is a data structure located within heap 410. This list is allocated by memory management process 400. This particular data structure contains a linked list of entries that identify delta data for various objects, such as object 406 and object 408.

In this example, object 406 includes object header 418 and object data 420. Object 408 includes object header 422 and object data 424. Object data 420 and object data 424 contain the data for the object in its current state. Object header 418 includes a pointer or offset to delta object linked list 416. In a similar fashion, object header 422 also includes a pointer or offset in the delta object linked list 416.

In allocating objects 406 and 408, memory management process 400 also includes an indicator or tag with object headers 418 and 422. As depicted, object header 418 contains tag 426, and object header 422 contains tag 428. These indicators or tags are used to identify objects 406 and 408 as objects for which delta data will be stored to allow restoring these objects to a prior state.

When application 402 changes an object, such as object 406, memory management process 400 creates an entry within delta object linked list 416 to store the delta data. Specifically, any changed values in object 406 are stored within delta object linked list 416 in association with the identification of object 406 and an index, such as a numerical value or a timestamp.

This change in data may be stored every time an object is changed. Alternatively, the changes may be stored only when an application changes the data through an API call that includes an additional parameter or argument that indicates that the change is to occur. An example of an API call is set_version (object reference, object version). The object reference is the identification of the object, and the object version provides an identifier. Alternatively, the object version may be excluded from the call. In this case, memory management process 400 may generate a version identifier to return to the application making the call.

In this manner, all changes to object 406 are stored within delta object linked list 416. Thus, object 406 may be returned to any prior state desired using this data structure.

If a request is received by memory management process 400 to restore one of the objects in the heap to a prior state, the process identifies the object and an index to identify the state that is desired. An example of an API call is restore_version (object reference, object version). The object reference is a pointer to the object that is to be restored. The object version is an index used to identify the version of the object that is to be restored.

This index may be, for example, a numerical value or a timestamp. If, for example, object 406 is identified in the request, the object header is used to find delta object linked list 416. The index in the request is used to identify the desired state for object 406. Based on the particular entry identified in delta object linked list 416, the linked list may be traversed to make the appropriate changes to object 406 to return that object to the desired prior state.

In these depicted examples, all of the delta data for all objects is stored within delta object linked list 416. The entries that apply to a particular object may be identified through an object identifier that is found within each entry of delta object linked list 416.

In other illustrative examples, a separate linked list data structure may be used for each object. In this case, the object header provides an offset to the particular linked list data structure for that object.

Memory management process 400 may check delta object linked list 416 to determine whether any of the versioning data in this data structure is considered to be old versioning data. This check may be performed in a number of different ways. For example, a threshold may be specifically set such that delta data that is older than a selected time period is stored in a persistent storage. In this example, delta data that is considered to be old is stored as old versioning data 426 in disk 428.

Other types of thresholds may be used, depending on a particular implementation. For example, if available memory in the heap is less than some specified threshold level, the oldest versioning data for different objects, such as objects 406 and 408, is removed from heap 410. In these examples, this versioning data is stored in old versioning data 426. Another threshold that may be used is based on a version identifier. If a version identifier for a particular object reaches or exceeds a threshold value, then versioning data for the oldest versions are moved to old versioning data 426 in disk 428.

Old versioning data 426 is indexed or associated with version tags or other identifiers to allow versioning data in old versioning data 426 to be searched and located. With old versioning data 426 in disk 428 memory resources in heap 410 may be made available to other active programs, while persisting the old versioning data in a manner such that it may be retrieved at some point in time.

Such a feature is especially useful for applications that are used in transactional auditing and debugging. For example, if a salary object is set as versionable, delta data is created each time the salary object is called. With the ability to move old versioning data from heap 410 into a persistent storage such as disk 428, a history of all of the changes made to this object may be retained for later use. With respect to debugging objects, the saving of delta data for objects may be used at a later time to see what the object looked like at a particular point in time.

In this manner, the mechanism of the present invention provides for efficient management of a versioned heap, such as heap 410. This mechanism also provides the ability to make versioning data, such as delta data at a later point in time. Although the examples illustrate versioning data in the form of delta data, the mechanism of the present inventions may be applied to versioning data in other forms. For example, in some cases the versioning data may contain entire copies of an object at a particular point in time.

In these illustrative examples, memory management process 400 may include processes for performing garbage collection on heap 410. As depicted, virtual memory 430 is used by memory management process 400 as a place to move portions of heap 410 for purposes of freeing or reclaiming memory as part of a garbage collection process. Specifically, portions of heap 410 may be placed into swap file 432, which is on a disk in these examples. Virtual memory 430 may be implemented using any type of available persistent storage in these examples.

When a garbage collection process is initiated, live objects in portions of heap 410 are identified and marked. Thereafter, these portions of heap 410 are written into virtual memory 430. At that time, old objects may be identified and the space in these portions of heap 410 located in virtual memory 430 may be freed. If an object located in virtual memory 430 is referenced or accessed, that object is swapped back into heap 410 from virtual memory 430. This process may be performed on part or all of heap 410. Delta object linked list 416 may be pre-sorted by age, thus allowing the process to optimize jumping ahead to the oldest data to be archived and indicating when all objects in a range are archived.

Old objects that are swept or removed to free up memory may be placed onto a disk, such as disk 428. As old objects are moved into virtual memory, the available space in the heap increases. Consequently, the garbage collection routine will execute less frequently, thereby freeing process cycles for active threads. This garbage collection mechanism may be combined with the versioning process described herein to store old versioning data in old versioning data 426.

In these illustrative examples, memory management process 400 initiates and controls garbage collection within heap 410 using the mechanism of the present invention. Alternatively, the movement of an object from heap 410 into persistent storage swap file 432 in virtual memory 430 may be initiated by an application, such as application 402. Application 402 initiates this movement of the object through API call 412 to memory management process 400. In this manner, application 402 may be allowed to age objects. This feature is especially useful for objects controlled by an application. For example, a shopping cart application may receive user input indicating that shopping cart object will not be used for a long period of time, such as a day. In this instance, the shopping cart object does not need to remain in heap 410. The shopping cart application sends an API call to memory management process 400 to cause this object to be moved to virtual memory 430. Memory management process 400 may move this object back to heap 410 the next time the object is referenced by the shopping cart application.

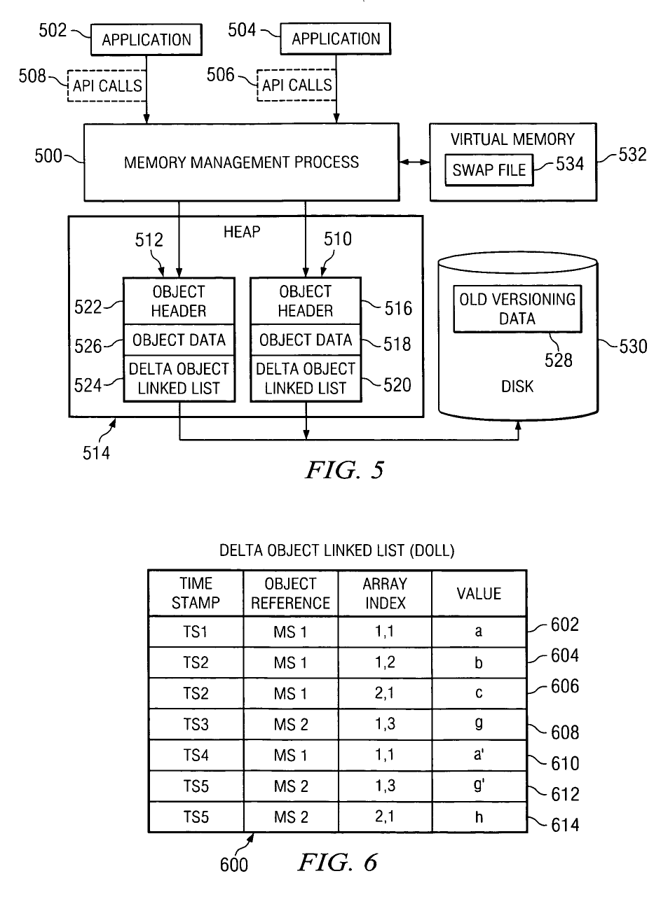

FIG. 5 is a diagram illustrating components used in providing data versioning and recovery management in accordance with a preferred embodiment of the present invention. In this example, the versioning data, also referred to as delta data, is stored within the objects.

In this illustrative example, memory management process 500 receives requests from application 502 and application 504 in the form of API calls 506 and 508 to create objects 510 and 512 for use by the applications. In this example, object 510 is created for use by application 502, and object 512 is created for use by application 504. Memory management process 500 may be implemented within memory management 310 in FIG. 3. In these examples, objects 510 and 512 contain delta data that allows these objects to be restored to a prior version or state.

Objects 510 and 512 are located in heap 514. Object 510 includes object header 516, object data 518, and delta object linked list 520. Object header 516 includes an offset to point to the beginning of delta object linked list 520 in this illustrative example. Object data 518 contains the current data for object 510. Delta object linked list 520 contains entries that identify all of the delta data for object 510. In a similar fashion, object header 522 provides an offset to the beginning of delta object linked list 524. Object data 526 contains the current data for object 512. Delta object linked list 524 contains all the delta data for changes made to object data 526. These types of objects are created when a call to allocate an object includes an additional parameter or argument that indicates that the object should be restorable to a prior state. If this additional argument or parameter is missing, the object is allocated normally.

In this illustrative example, memory management process 500 automatically increases the size of object 510 in response to a request to allocate object 510 in which the request includes an indication that object 510 is to store data needed to restore object 510 to a prior version or state. This increased size includes space needed to store the delta data.

In addition to allocating these objects in response to a specific call requesting data versioning for the objects, this type of allocation for objects 510 and 512 may be performed automatically without requiring an application or a user to request the additional memory to store delta data. Additionally, memory management process 500 may allocate more space for object 510 and object 512 as the object data and the delta data increase for these objects.

In this particular illustrative embodiment, these objects may be moved and copied such that the delta data automatically is moved or copied with the objects. In this manner, an object may be saved and reloaded at a later time with its delta data intact. In this fashion, an object may be restored to a prior state at any time without having to locate or save data objects from the heap and restore those objects separately.

In this illustrative example, memory management process 500 may also move versioning data out of heap 514 to form old versioning data 528 in disk 530. In this example, delta data from delta object link lists 520 and 524 may be moved into old versioning data 528. This movement of delta data may occur in response to data being older than some particular date or when a version exceeds a threshold. Additionally, delta data may be moved out of heap 514 in response to available memory being less than some threshold level.

Memory management process 500 may perform a garbage collection process on heap 514 in a fashion similar to memory management process 400 in FIG. 4. In these examples, portions of heap 514 may be placed into virtual memory 532. Specifically, live objects are marked in these portions of heap 514. Afterwards, these portions may be placed into swap file 534. At that time, space in these portions of heap 514 in swap file 534 may be freed to provide space for new objects.

FIG. 6 is a diagram illustrating a delta object linked list in accordance with a preferred embodiment of the present invention. In the depicted example, delta object linked list 600 is an example of delta object linked list 416 as created by memory management process 400 in FIG. 4.

In these illustrative examples, delta object linked list 600 contains entries 602, 604, 606, 608, 610, 612, and 614. As shown, each of these entries contains a time stamp, an object reference, an array index, and a value. The time stamp indicates when the entry was made. The object reference is the pointer to the object for the entry. The array index identifies the location in which data has changed, and the value indicates the change in the data at that location.

In this illustrative example, the prior state is identified through a timestamp. If the memory management subsystem receives a request identifying a particular timestamp and object, the object may be returned to that state. Entry 614 is the most recent entry, while entry 602 is the oldest entry. Entries 602, 604, 606, and 610 are entries for one object, MS 1. Entries 608, 612, and 614 are entries for another object, MS 2. The mechanism of the present invention traverses the linked list from the most current entry to the entry identified by the timestamp. Entries for objects other than the selected object are ignored.

This type of traversal and restoration of data is provided as one manner in which an object may be restored to a prior state. Of course, any process used to return an object to a prior state using delta data may be employed in these illustrative examples.

The delta in data may be identified or calculated in a number of different ways. In these examples, the delta data may be calculated using an exclusive OR (XOR). In other words, the value of prior data may be XOR'd with the value of the current data to identify the change in the current data as compared to the prior data. The result of this function is considered the delta in the data in this example. With this delta, the current data may be restored to the value of the current data. The data may be, for example, the values for data in all of the heaps managed by a memory management system. The delta in the data also may be calculated using Moving Picture Experts Group processes, such as MPEG 2. With these processes, every delta is similar to a video frame with respect to normal use in processing video data. Instead, the deltas are for one or more memory segments. As with a video, in which not every pixel necessarily changes from frame to frame, not all of the data elements within a memory segment may change from one delta to another delta. Compression algorithms, similar to MPEG2, can be employed which minimize the amount of memory required to store the necessary information, or delta, to restore the memory segments to prior values.

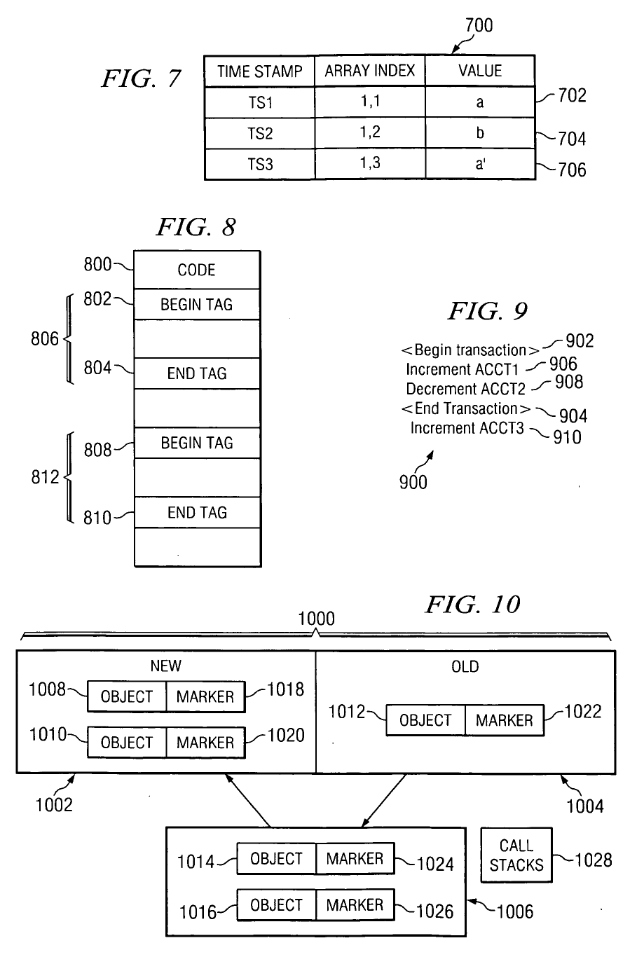

FIG. 7 is a diagram of a delta object linked list in accordance with a preferred embodiment of the present invention. Delta object linked list 700 is an example of a list that is found in an object. In particular, a delta object linked list may be implemented as delta object linked list 520 in object 510 in FIG. 5.

As shown, delta object linked list 700 includes entries 702, 704, and 706. Each entry includes a time stamp, an array index, and a value. An object reference is not included in this list as with delta object linked list 600 in FIG. 6 because this list is contained within the object for which changes in data, delta data, is stored.

Although FIGS. 6 and 7 specify types of changes in data in which an array is used to identify where changes in data have occurred, any type of system may be used to identify changes in data.

Additionally, the mechanism of the present invention allows for portions of code to be marked in which objects on the marked portions are tracked for changes. This mechanism is implemented in a memory management process, such as memory management process 500 in FIG. 5.

FIG. 8 is a diagram illustrating marked code in accordance with a preferred embodiment of the present invention. This marking is used to track changes for the marked portions of code 800. In this illustrative example, code 800 is marked using begin tag 802 and end tag 804 to create marked portion 806. Additionally, begin tag 808 and end tag 810 define marked portion 812.

Any alterations or changes to objects in marked portion 806 and marked portion 812 are tracked in the manner described above. This type of tracking does not require calls to be made by the application to identify particular objects. With this marking mechanism, the speed of execution in a data processing system is increased because only objects of interest are versioned instead of all objects when data changes during execution of code.

FIG. 9 is an example of marked code in accordance with a preferred embodiment of the present invention. Code 900 is an example of a marked portion of code, such as marked portion 806 in FIG. 8. Line 902 is an example of a begin tag, while line 904 is an example of an end tag. Line 906, line 908, and line 910 contain instructions that alter objects.

When line 902 is encountered during the execution of code 900, any changes to objects are tracked. Execution of line 906 results in the changes to object ACCT1 being tracked. In other words, the change is stored in a data structure such as delta object linked list 700 in FIG. 7. In this manner, this object may be restored to a prior version or state. Execution of line 908 results in a similar storing of data for object ACCT2. When line 904 is encountered, tracking changes to objects no longer occur when the execution of line 910 occurs incrementing the object ACCT3.

The tags illustrated in FIGS. 8 and 9 may be placed in to the code using different mechanisms. For example, a programmer may manually insert these tags through a user interface. Alternatively, the user interface may allow a user to select a portion of a code, such as a class or set of classes. In this example, the user enters the name of the class and the memory management process locates and inserts tags around the class.

FIG. 10 is a block diagram of components illustrating managing a heap in accordance with a preferred embodiment of the present invention. Heap 1000 is an example of a heap that may be managed using the mechanisms of the present invention. Heap 1000 is divided into two portions in this illustrative example. The sections include new portion 1002 and old portion 1004. These two sections are located in memory. Persistent storage 1006 is used to store old objects that are removed from heap 1000 in response to some event. This event may be a periodic event or even a request from an application. Persistent storage in these examples is located in a storage device, such as a hard disk drive or tape drive.

In this illustrative example, objects 1014 and 1016 are objects that have been swept from or removed from old portion 1004. New portion 1002 contains live objects, such as objects 1008 and 1010. Old portion 1004 contains old objects, such as object 1012.

The mechanism of the present invention identifies the age of objects based on the address of the objects in these illustrative examples. Objects located in the address space for new portion 1002 are not as old as objects located in the address space for old portion 1004. Of course additional sections may be used to provide a finer granularity in identifying the age of objects.

Additionally, objects may be sorted based on the address space. With this example, the mechanism of the present invention pushes or moves an object lower in the address space in response to a determination that the object has not been touched or referenced within a specific period of time. In this example, all of the objects below the one being examined are moved to a lower address in heap 1000. The lowest object may be moved to persistent storage 1006. The mechanism of the present invention also may move all of the objects in old portion 1004 into persistent storage 1006. The particular manner in which objects are moved into persistent storage 1006 depends on the particular implementation.

The mechanism of the present invention determines when an object was last referenced by using markers in this illustrative example in FIG. 10. For example, markers 1018 and 1020 are associated with objects 1008 and 1010 in new portion 1002. Object 1012 in old portion 1004 contains marker 1022. Object 1014 is associated with marker 1024 and object 1016 is associated with marker 1026 in persistent storage 1006. These markers may take various forms. In these illustrative examples, the markers take the form of a bit mask, which is a pattern of binary values. The mechanism of the present invention selectively sets these bits in the bit mask to identify when an object is referenced each time an object associated with the bit mask is referenced.

When an object in persistent storage is referenced, the mechanism of the present invention moves that object back into heap 1000. In these examples, the referenced object is moved into new portion 1002.

Although the illustrative examples use markers in the form of bit masks to identify when an object has been last referenced, other types of markers, such as a time stamp may be used. Additionally, call stacks 1028 may be used to identify the age of an object in heap 1000. Each time a method is called, a call stack is created in call stacks 1028. This call stack identifies the caller of different methods. The mechanism of the present invention adds a time stamp to an entry in the call stack when a call references an object in heap 1000. In this manner, the mechanism of the present invention identifies the age of objects in heap 1000 without requiring markers to be located in or associated with the objects.

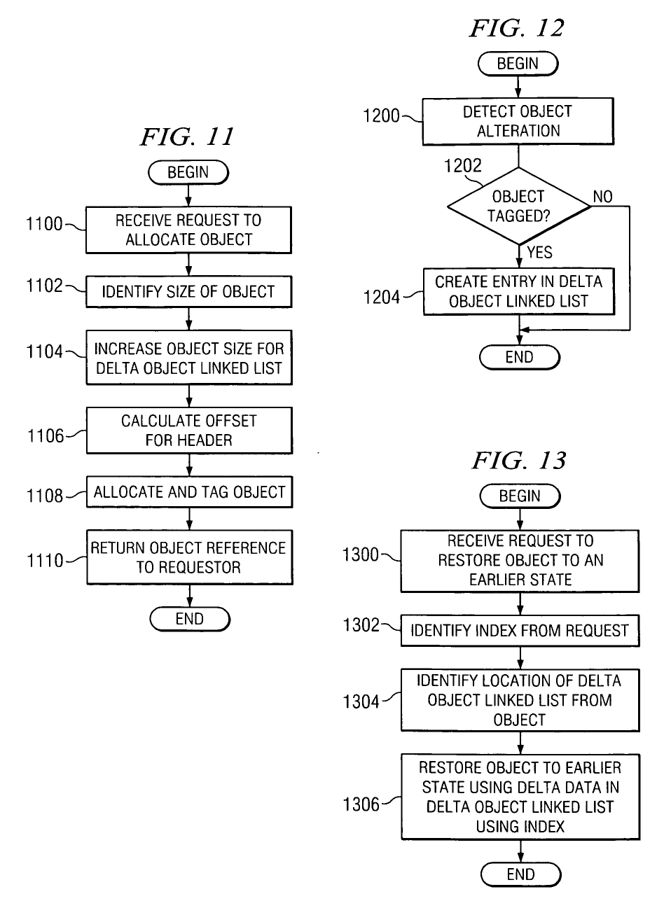

FIG. 11 is a flowchart of a process for allocating objects in accordance with a preferred embodiment of the present invention. The process illustrated in FIG. 11 may be implemented in a memory management process, such as memory management process 400 in FIG. 4.

The process begins by receiving a request to allocate an object (step 1100). In these examples, the request is received from an application, such as application 402 in FIG. 4, in the form of an API call to the JVM. In response, the size of the object is identified (step 1102). Several options exist as to where, in memory, to place the delta object linked list. The consideration of which option to choose is based upon tradeoffs in performance and or memory usage. In a preferred performance optimized embodiment, the delta object linked list is co-resident in memory with the data element for which it contains delta information. In this case, at object creation, memory is allocated sufficient to contain both the data element and an estimated size for the delta object linked list. In these examples, the estimated size being calculated primarily by the number of deltas desired to be retained. The object size for the object is increased to include the delta object linked list (step 1104).

Next, an offset is calculated and stored in the object header (step 1106). This offset is used by the memory management subsystem to point to the delta object linked list. The object is then allocated and tagged (step 1108). The object is tagged by including a tag or indicator within the object. This tag or indicator is used to identify the object as one in which delta data is stored for versioning. An object reference is then returned to the requestor (step 1110). This object reference is used by the requester to write or read the object.

At this point, the requester may access the allocated object. In these illustrative examples, step 1104 may be an optional step depending on the particular implementation. In the instance in which the delta object linked list is allocated as a separate data structure from the object, this step may be skipped.

FIG. 12 is a flowchart of a process for storing delta data in accordance with a preferred embodiment of the present invention. The process illustrated in FIG. 12 may be implemented in a memory management process, such as memory management process 400 in FIG. 4.

The process begins by detecting an alteration of the data in the object (step 1200). This step may occur in different ways; for example, when the memory management process receives a request to change data in an object. When that change is processed, a determination is made as to whether the object is tagged (step 1202). The tag is used to indicate whether the object is set up such that changes in data can be stored for the object. If the object is tagged, an entry is created in the delta object linked list (step 1204) with the process terminating thereafter. Otherwise, the process terminates without storing the delta data. The linked list in step 1204 may be a combined linked list for all objects being managed. Alternatively, the linked list may be one that was created within the object when the object was allocated or as a separate linked list associated with the object.

FIG. 13 is a flowchart of a process for returning an object to an earlier state in accordance with a preferred embodiment of the present invention. In this illustrative example, the process in FIG. 13 may be implemented in a memory management process, such as memory management process 400 in FIG. 4 or memory management process 500 in FIG. 5.

The process begins by receiving a request to restore an object to an earlier state (step 1300). This request may be received from an application or a user input. Additionally, the request may be received from another process, such as an operating system or JVM process requiring the object to be returned to some other state. An index and an object identifier are identified from the request (step 1302). The location of the delta object linked list is identified from the object (step 1304). In step 1304, the location of the delta object linked list is identified using the offset from the object header. Thereafter, the object is restored to the earlier state using the delta data in the delta object linked list using the index (step 1306) with the process terminating thereafter.

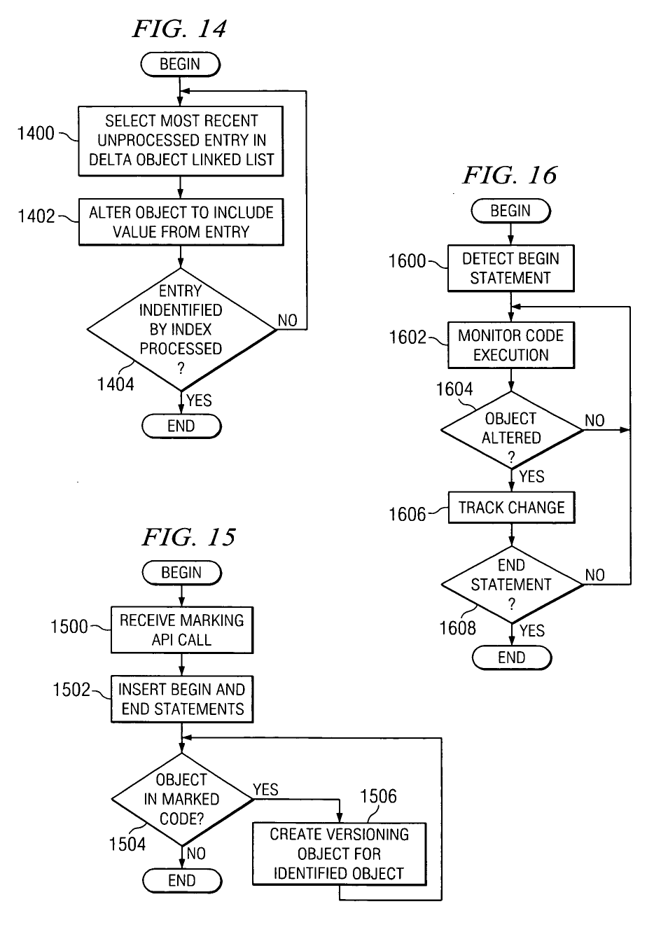

FIG. 14 is a flowchart of a process for restoring an object to an earlier state in accordance with a preferred embodiment of the present invention. The process illustrated in FIG. 14 is a more detailed description of step 1306 in FIG. 13.

The process begins by selecting a most recent unprocessed entry in the delta object linked list (step 1400). The object is then altered to include the value from the entry (step 1402). Next, a determination is made as to whether an entry identified by the index has been processed (step 1404). This step determines whether the particular index, such as a timestamp for the object, has been processed. If this entry has been processed, the object has then been returned to the desired state with the process terminating thereafter.

Otherwise, the process returns to step 1400 to select the next most recent unprocessed entry in the delta object linked list. In the instance in which the linked list includes entries for other objects, a determination may be included to determine whether the object identifier is for the object that is being restored.

FIG. 15 is a flowchart of a process for marking code for versioning in accordance with a preferred embodiment of the present invention. The process illustrated in FIG. 15 may be implemented in a memory management process, such as memory management process 500 in FIG. 5.

The process begins by receiving a marking API call (step 1500). This call may be, for example, an API call that includes the name of a class as a parameter. Begin and end statements are inserted into the code (step 1502). Next, a determination is made as to whether an unprocessed object is present in the marked code (step 1504). If an unprocessed object is present, the object is processed by creating a versioning object for the identified object (step 1506). Step 1506 allows for delta data to be stored during execution of the code. Thereafter, the process returns to step 1504 to determine whether additional unprocessed objects are present. The process terminates when all of the objects in the marked code have been processed.

FIG. 16 is a flowchart of a process for tracking changes in data in accordance with a preferred embodiment of the present invention. The process illustrated in FIG. 16 may be implemented in a memory management process such as memory management process 500 in FIG. 5.

The process begins by detecting a begin statement (step 1600). Code execution is then monitored (step 1602). A determination is made as to whether an object has been altered (step 1604). If the object is altered, the change is tracked (step 1606). Next, a determination is then made as to whether an end statement has been encountered (step 1608). If an end statement has been encountered, the process is then terminated.

Turning back to step 1604, if a determination is made that no object has been altered, the process returns back to monitor code execution (step 1602). The process also returns to step 1602 if an end statement is not found in step 1608.

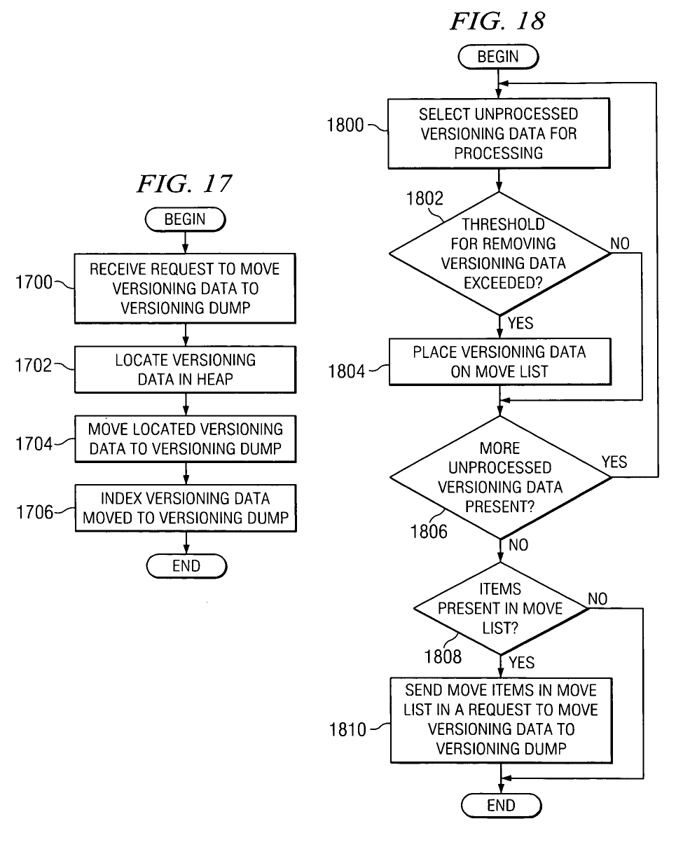

FIG. 17 is a flowchart of a process for managing versioning data in a heap in accordance with a preferred embodiment of the present invention. The process illustrated in FIG. 17 may be implemented in a memory management component, such as memory management process 400 in FIG. 4.

The process begins by receiving a request to move versioning data to a versioning dump (step 1700). This versioning dump is a persistent storage such as a disk or tape. This versioning dump also may be referred to as a historical dump. This request may be initiated from a process within a memory management component indicating that versioning data should be moved from the heap into the versioning dump. In this example, the request includes an identification of the versioning data that is to be moved. Specifically, the versioning data may be delta data for objects in the heap. The versioning data in the heap is located (step 1702). The located versioning data is moved to the versioning dump (step 1704). The index versioning data is moved to the versioning dump (step 1706) with the process terminating thereafter. This indexing is performed in this example to allow the versioning data in the versioning dump to be located and accessed at a later point in time.

FIG. 18 is a flowchart of a process for moving versioning data to a persistent storage in accordance with a preferred embodiment of the present invention. The process illustrated in FIG. 18 may be implemented in a memory management component such as memory management process 400 in FIG. 4.

The process begins by selecting unprocessed versioning data for processing (step 1800). A determination is made as to whether a threshold for removing versioning data has been exceeded (step 1802). This threshold may take many different forms. For example, the threshold may be a particular age or date for versioning data. The threshold also may be, for example, a versioning identifier. If the threshold for removing versioning data has been exceeded, the versioning data is placed on a move list (step 1804). A determination is made as to whether more unprocessed versioning data is present (step 1806). If more unprocessed versioning data is not present, a determination is made as to whether the items are present in the move list (step 1808). If the items are present in the move list, the items in the move list are sent in a request to move versioning data to a versioning dump (step 1810) thus ending the process. This request is sent to another process within the memory management component in this illustrative example.

Turning back to step 1802, if a threshold for removing versioning data has not been exceeded, the process then proceeds to step 1806 to determine whether more unprocessed versioning data is present. With regards to step 1806, if more unprocessed versioning data is present, the process returns to step 1800 to select more unprocessed versioning data for processing. Turning back now to step 1808, if items in move list are not present, the process terminates. Although the examples describe initiating the movement of versioning data when a threshold is exceeded, the movement of versioning data may be initiated when the threshold is reached, depending on the particular implementation.

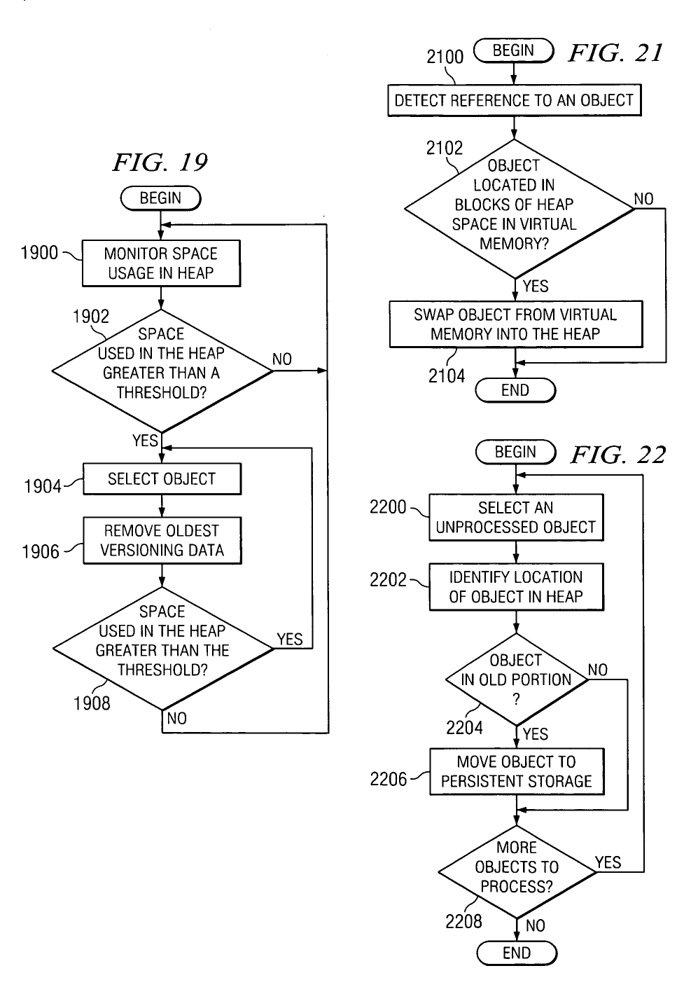

FIG. 19 is a flowchart of a process for performing garbage collection on a heap containing versioning data in accordance with a preferred embodiment of the present invention. The process illustrated in FIG. 19 may be implemented in a memory management component, such as memory management process 400 in FIG. 4.

The process begins by monitoring space usage in the heap (step 1900). This space usage may be with respect to all space used by the objects and versioning data. Alternatively, in another example, the monitoring may be with respect to space used in the heap by the versioning data. A determination is made as to whether the space used in the heap is greater than a threshold (step 1902). The determination also may be made as to whether the space used reaches the threshold, depending on the particular implementation. In this example, the threshold is explicit in that once the versioning data or all of the data in the heap reached a selected size, versioning data is moved to a persistent storage such as disk 428 in FIG. 4.

If the space used in the heap is not greater than the threshold, the process returns to step 1900 to continue to monitor space usage in the heap. Otherwise, an object in the heap is selected (step 1904). The oldest versioning data for that object is moved to a versioning dump (step 1906). Next, a determination is made as to whether the space used in the heap is greater than the threshold (step 1908).

If the space used in the heap is not greater than the threshold, then the process returns to step 1900 to continue to monitor space usage in the heap.

Otherwise, the process returns to step 1904 to select an object for which versioning data is to be removed from the heap. This object could be the same object previously selected or another object, depending on the particular algorithm used to select objects used.

In step 1906, the versioning data selected is the oldest versioning data for the selected object. Other factors may be used in addition to the age of the versioning data. For example, the versioning data may be selected as the versioning data for an object that is the largest and oldest version of data for a particular object. This type of policy for selecting versioning data also affects the manner in which objects are selected in step 1904. In this case, if multiple objects have the versioning data of the same age, the object with the largest version of data of that age is selected.

The threshold in step 1902 is an explicit threshold. A deterministic process may be used in step 1902 in another illustrative example. In this case, the memory management subsystem may monitor usage and move older versions of versioning data to a persistent storage when performance parameters, such as access speed reach or exceed a threshold.

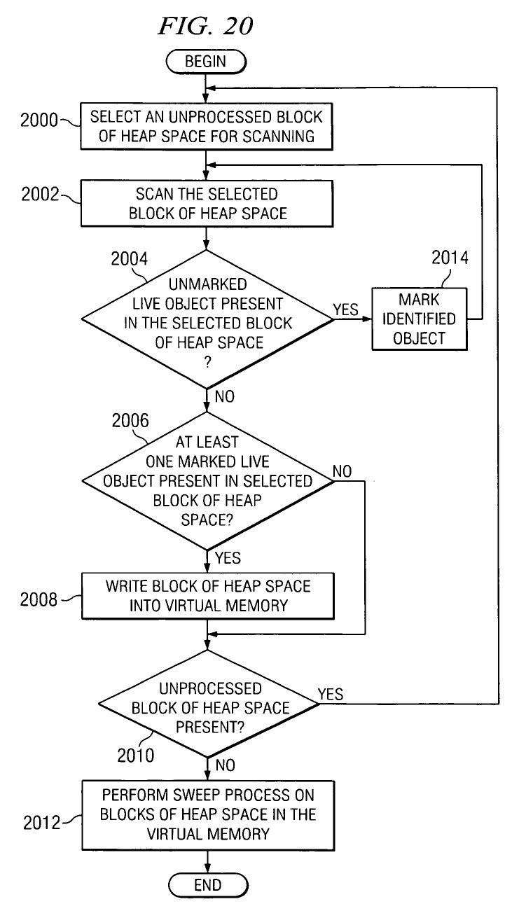

FIG. 20 is a flowchart of a process for reclaiming memory in a heap in accordance with a preferred embodiment of the present invention. The process illustrated in FIG. 20 may be implemented in a memory management system, such as memory management process 400 in FIG. 4.

The process begins by selecting an unprocessed block of heap space for scanning (step 2000). The selected block of heap space is scanned (step 2002). Step 2002 is used to identify a live object. In this illustrative example, a live object is an object still needed by an application or program. An object is considered live when referenced by a program or another object. An object is no longer alive and is called old when that object is no longer needed.

A determination is made as to whether an unmarked live object in the selected block of heap space is present (step 2004). If an unmarked live object in the selected block of heap space is not present, a determination is made as to whether at least one marked live object in the selected block of heap space is present (step 2006). If at least one marked live object in the selected block of heap space is present, the block of heap space is written into virtual memory (step 2008). Next, a determination is made as to whether an unprocessed block of heap space is present (step 2010). If an unprocessed block of heap space is not present, a sweep process is performed on the blocks of heap space in virtual memory (step 2012) with the process terminating thereafter. This sweep process is a process used to free or reclaim memory or space in the blocks of heap space in the virtual memory.

Turning back to step 2004, if an unmarked object in the selected block of heap space is present, the identified object is marked (step 2014) with the process returning to step 2002 to scan the selected block of heap space. The process continues to loop back to step 2002 from step 2014 until all of the live objects in the selected block of heap space have been marked.

Turning back to step 2006, if at least one marked live object in the selected block of heap space is not present, the process proceeds to step 2010 to determine whether an unprocessed block of heap space is present. If an unprocessed block of heap space is present, the process returns back to step 2000 to select an unprocessed block of heap space for scanning.

FIG. 21 is a flowchart of a process for swapping an object from virtual memory into a heap in accordance with a preferred embodiment of the present invention. The process illustrated in FIG. 21 may be implemented in a memory management system, such as memory management process 400 in FIG. 4.

The process begins by detecting a reference to an object (step 2100). A determination is made as to whether an object is located in blocks of heap space in virtual memory (step 2102). If an object is located in blocks of heap space in virtual memory, the object in virtual memory is swapped into the heap (step 2104) with the process terminating thereafter. The process also terminates in step 2102 if an object is not located in blocks of heap space in the virtual memory.

FIG. 22 is a flowchart for moving objects into persistent storage based on addresses of the objects in accordance with a preferred embodiment of the present invention. The process illustrated in FIG. 22 may be implemented in a memory management process, such as memory management process 400 in FIG. 4. This process is another mechanism of the present invention used to reclaim space in a heap.

The process begins by selecting an unprocessed object (step 2200). The process identifies the location of the object in the heap (step 2202). In these examples, the heap is divided into two portions, a new portion and an old portion. A determination is made as to whether the object is in an old portion (step 2204). If the object is present in an old portion, the process moves the object to a persistent storage (step 2206). Next, a determination is made as to whether more objects are present to process (step 2208). If no more objects to process are present, the process terminates. In the same manner, if more objects to process are present, the process returns to step 2200 to select another unprocessed object.

Turning back to step 2204, if the object is not present in an old portion, the process proceeds to step 2208 to determine whether there are more objects to process.

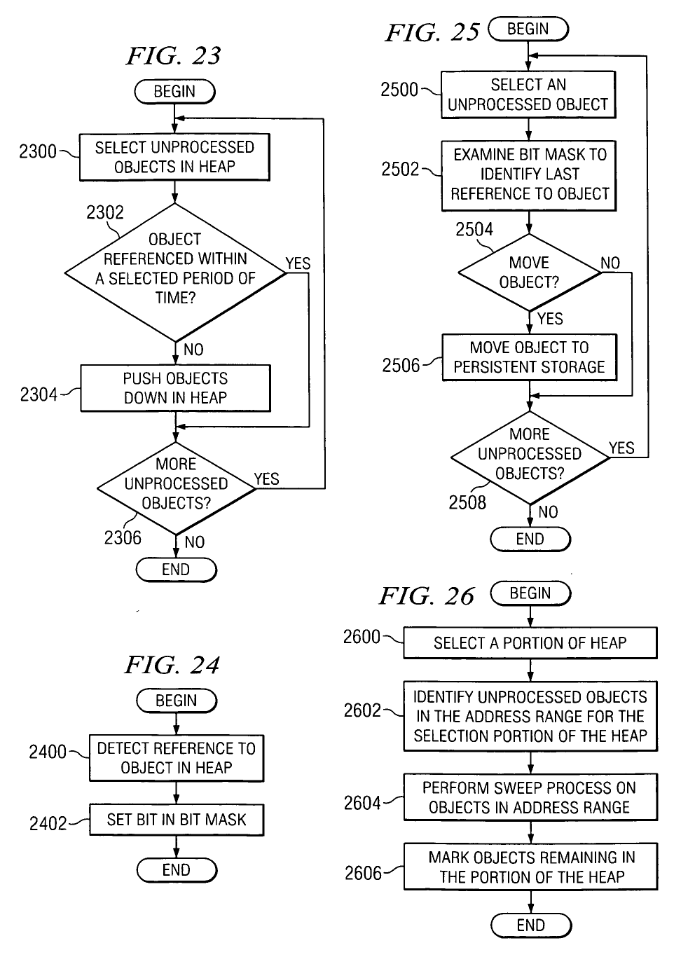

FIG. 23 is a flowchart for aging objects in a heap in accordance with a preferred embodiment of the present invention. The process in FIG. 23 may be implemented in a memory management process, such as memory management process 400 in FIG. 4. This process is used to age objects such that objects may be moved into persistent storage from the heap to reclaim space in the heap.

The process begins by selecting unprocessed objects in a heap (step 2300). A determination is made as to whether the object has been referenced within a configurable period of time (step 2302), the duration of which is dependent upon the executing application. For example, in the shopping cart example, the duration may be twenty-four hours. If the object has not been referenced within a selected period of time, the object is pushed down in the heap (step 2304). The object is pushed down in the heap by moving the object to a lower address in the heap in these illustrative examples. In these illustrative examples, selected objects below the configured duration are moved down. Next, a determination is made as to whether there are more unprocessed objects (step 2306). If no more unprocessed objects are present, the process terminates. If more unprocessed objects are present, the process returns to step 2300 to select more unprocessed objects in the heap.

FIG. 24 is a flowchart for identifying when an object has been referenced in accordance with a preferred embodiment of the present invention. The process in FIG. 24 may be implemented in a memory management process, such as memory management process 400 in FIG. 4.

The process begins by detecting a reference to an object in the heap (step 2400). The bit is set in the bit mask (step 2402) with the process terminating thereafter.

FIG. 25 is a flowchart for moving objects to persistent storage in accordance with a preferred embodiment of the present invention. The process in FIG. 25 may be implemented in a memory management process, such as memory management process 400 in FIG. 4. The process in this illustrative example is used to move aged objects into a persistent storage from a heap.

The process begins by selecting an unprocessed object (step 2500). The process examines the bit mask to identify if the object has been referenced since the last time the object marking was done (step 2502). A determination is made as to whether to move an object (step 2504). If an object to be moved is present, the process moves the object to a persistent storage (step 2506). Next, a determination is made as to whether more unprocessed objects are present (step 2508). If more unprocessed objects are not present, the process terminates.

Turning back to step 2504, if an object to be moved is not present, the process proceeds to step 2508 to determine whether more unprocessed objects are present.

With reference again to step 2508, if more unprocessed objects are present, the process returns to step 2500 to select another unprocessed object.

FIG. 26 is a flowchart for processing a portion of a heap in accordance with a preferred embodiment of the present invention. The process in FIG. 26 may be implemented in a memory management process, such as memory management process 400 in FIG. 4.

The process begins by selecting a portion of the heap (step 2600). The process identifies unprocessed objects in the address range for the selected portion of the heap (step 2602). The process initiates a sweep process on the objects in the address range (step 2604). The process marks objects remaining in the portion of the heap (step 2606) with the process terminating thereafter.

Thus, the present invention provides an improved method, apparatus, and computer instructions for saving delta data and restoring an object to a prior state using the delta data. This mechanism is accessed through API calls to the JVM. In these examples, a data structure containing entries is used to store changes in the data and memory segments. This data structure takes the form of a linked list in these illustrative examples. Of course, other types of data structures may be used, such as, for example, a table. In the depicted examples, the linked list may be a single linked list for all objects being managed by a memory management subsystem. Alternatively, in another embodiment, this data structure may be located as part of the object or in a separate data structure in which each data structure is associated with a particular object that is being managed by the memory management subsystem.

The present invention also allows for marking sections of code for tracking changes to objects in the marked sections. Further, a user may specify a class or set of classes that are to be marked through an application in the form of a user interface.

Further, the mechanism of the present invention provides an ability to manage versioning data in a heap. This data is moved to a persistent storage, such as a version dump, when certain thresholds are reached or exceeded.

Moreover, the mechanism of the present invention allows for reclaiming memory in a heap in a manner reducing the need to lock threads that may access objects in a heap. Live objects are identified in portions of the heap. These portions of the heap are then moved to virtual memory. Space in the portions of the heap is reclaimed in the virtual memory. This mechanism allows for the reclaiming of memory to occur in the background. The mechanism of the present invention also reclaims space in the heap by marking live objects and moving portions of the heap into a virtual memory. Selected objects in the portions of the heap moved into the virtual memory may be moved into a persistent storage. Objects are aged in these illustrative examples. The objects in these portions of the heap in the virtual memory may be processed to move objects that are older than some selected threshold into a persistent storage. In this manner, space in the heap may be reclaimed for use. The objects in the persistent storage may be moved back into the heap when those objects are referenced.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing a heap, the method comprising:
responsive to a request to reclaim space in the heap, marking live objects in portions of space in the heap;
responsive to marking the live objects, moving the portions of space into a virtual memory; and
removing old objects from the portions of space in the heap in the virtual memory.

2. The method of claim 1, wherein the removing step is performed by sweeping the portions of the space in the heap in the virtual memory.

3. The method of claim 1, wherein the portions of space is all of the space in the heap.

4. The method of claim 1, wherein the portions of space in the heap in the virtual memory are stored in a swap file.

5. The method of claim 1 further comprising:
responsive to an object in the portions of space in the heap in the virtual memory being referenced, swapping the object back into the heap.

6. The method of claim 1, wherein the removing step is performed as part of a sweep phase in performing garbage collection on the portions of space in the heap in virtual memory.

7. The method of claim 1, wherein the removing step is performed as a background operation.

8. The method of claim 1, wherein the removing step includes:
storing the old objects in a persistent storage.

9. The method of claim 1 further comprising:
receiving the request from an application.

10. The method of claim 1, wherein the portions of the heap have a selected address range.

11. The method of claim 1, wherein the marking step comprises:
moving a live object in the heap to a selected address based on an age of the object.

12. The method of claim 1, wherein the marking step comprises:
associating a time stamp with a live-object.

13. The method of claim 1, wherein the marking step comprises:
marking bit masks associated with the live objects, wherein the bit masks are used to identify old objects in the heap.

14. The method of claim 1, wherein an age of an object is stored in a call stack.

15. The method of claim 1, wherein an identification of objects is stored in entries in a data structure containing delta data or the objects and wherein the entries are sorted by age and indicates a range of entries for number of objects stored in persistent storage.

16. A computer program product in a data processing system for managing a heap, the computer program product comprising:
first instructions, responsive to a request to reclaim space in the heap, for marking live objects in portions of space in the heap;
second instructions, responsive to marking the live objects, for moving the portions of space into a virtual memory; and
third instructions for removing old objects from the portions of space in the heap in the virtual memory.

17. The computer program product of claim 16 further comprising:
fourth instructions for receiving the request from an application.

18. The computer program product of claim 16, wherein the first instructions comprises:
sub instructions for marking bit masks associated with the live objects, wherein the bit masks are used to identify old objects in the heap.

19. The computer program product of claim 16, wherein the portions of space in the heap in the virtual memory are stored in a swap file.

20. A data processing system comprising:
a bus;
a communications unit connected to the bus;
a memory connected to the bus, wherein the memory includes a set of instructions; and
a processor unit connected to the bus, wherein the processor unit executes the set of instructions to manage a heap; mark live objects in portions of space in the heap in response to a request to reclaim space in the heap; move the portions of space into a virtual memory in response to marking the live objects; and remove old objects from the portions of space in the heap in the virtual memory.
